(19) United States
(12) Patent Application Publication
(10) Pub. No.: US 2009/0234561 A1
(43) Pub. Date: Sep. 17, 2009

(54) METHOD TO ENABLE DIRECT INJECTION OF E85 IN FLEX FUEL VEHICLES BY ADJUSTING THE START OF INJECTION

(75) Inventors: Craig D. Marriott, Clawson, MI (US); Matthew A. Wiles, Royal Oak, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATIONS, INC., Detroit, MI (US)

(21) Appl. No.: 12/061,889

(22) Filed: Apr. 3, 2008

Related U.S. Application Data
(60) Provisional application No. 61/035,522, filed on Mar. 11, 2008.

(51) Int. Cl. F02D 45/00

(52) U.S. Cl. 701/105; 123/304

(57) ABSTRACT

An engine control system includes a fuel injector that injects a mixture of ethanol and gasoline directly into a combustion chamber of a spark-ignition direct-injection (SIDI) engine. A control module controls a start of injection of the fuel injector such that the start of injection occurs more than 335 crank angle degrees before a top dead center of a compression stroke of the engine (CAD bTDC).

### CROSS-REFERENCE TO RELATED APPLICATIONS

This application claims the benefit of U.S. Provisional Application No. 61/035,522, filed on Mar. 11, 2008. The disclosure of the above application is incorporated herein by reference.

### FIELD

The present disclosure relates to ethanol fuel injection timing in a spark-ignition direct-injection (SIDI) engine.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Spark-ignition direct-injection (SIDI) engines include one or more fuel injectors that inject fuel directly into associated engine cylinders. A fuel pump supplies fuel to a fuel rail at high pressure, e.g. 3-15 megapascals (435-2176 pounds per square inch). The fuel rail provides the pressurized fuel to the fuel injectors. The fuel injectors inject the fuel into the cylinders at times and pulse widths that are determined by an engine control module.

The duration of each pulse width is based in part on the type of fuel that is being injected. In one type of flex-fuel vehicle (FFV) the fuel may be gasoline or a mixture of gasoline and ethanol. The ratio of gasoline to ethanol may vary from pure gasoline, i.e. zero percent ethanol (E0), to 15% gasoline/85% ethanol (E85). Other ratios are also expressed as the percentage of ethanol, i.e. E25 is 75% gasoline/25% ethanol, and so forth. If other engine variables are held constant then the fuel injector pulse width becomes longer as the ethanol percentage increases.

The added fueling requirement of E85 fuel is challenging to accomplish for direct injection applications at peak power engine operating conditions. The challenge is due to the limited amount of time available for injection when faced with the added injection quantity of E85, as compared to gasoline. A simple increase in the flow rate of the injector, as is the case with port fuel injected engines, would prohibitively compromise the fuel control of gasoline operation at light engine loads due to the inherent dynamic range limitations of a solenoid injector.

### SUMMARY

An engine control system includes a fuel injector that injects a mixture of ethanol and gasoline directly into a combustion chamber of a spark-ignition direct-injection (SIDI) engine. A control module controls a start of injection of the fuel injector such that the start of injection occurs more than 335 crank angle degrees before a top dead center of a compression stroke of the engine (CAD bTDC).

In other features the start of injection occurs less than 360 CAD bTDC. The start of injection occurs while an exhaust valve of the engine is closed. The start of injection is based on a ratio of the ethanol to gasoline. The engine control system further includes a flexible fuel sensor that communicates a signal to the control module. The signal represents the ratio.

A method of controlling a spark-ignition direct-injection (SIDI) engine includes injecting a mixture of ethanol and gasoline directly into a combustion chamber of a SIDI engine and controlling a start of the injecting such that the start occurs more than 335 crank angle degrees before a top dead center of a compression stroke of the engine (CAD bTDC).

In other features the start occurs less than 360 CAD bTDC. The start occurs while an exhaust valve of the engine is closed. The start of the injecting with respect to CAD bTDC is based on a ratio of the ethanol to gasoline. The method includes determining the ratio.

A vehicle powerplant includes a reciprocating piston internal combustion engine, fuel injectors that inject a mixture of ethanol and gasoline directly into respective combustion chambers of the engine, and a control module that controls a start of injection of each fuel injector such that the start of injection occurs at least 335 crank angle degrees before a top dead center of a compression stroke (CAD bTDC) of an associated cylinder and the end of injection occurs by 58 CAD bTDC.

In other features the start of injection occurs between 360 CAD bTDC and 335 CAD bTDC. The start of injection occurs while an exhaust valve of the engine is closed. The start of injection is based on a ratio of the ethanol to gasoline. A flexible fuel sensor communicates a signal to the control module. The signal represents the ratio.

In still other features, the systems and methods described above are implemented by a computer program executed by one or more processors. The computer program can reside on a computer readable medium such as but not limited to memory, non-volatile data storage, and/or other suitable tangible storage mediums.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a spark-ignition direct-injection engine and associated engine control module;

FIG. 2 is a graph that shows exhaust smoke versus start of injection timing; and

FIG. 3 is a graph that shows coefficient of variation of indicated mean effective pressure versus start of injection timing.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

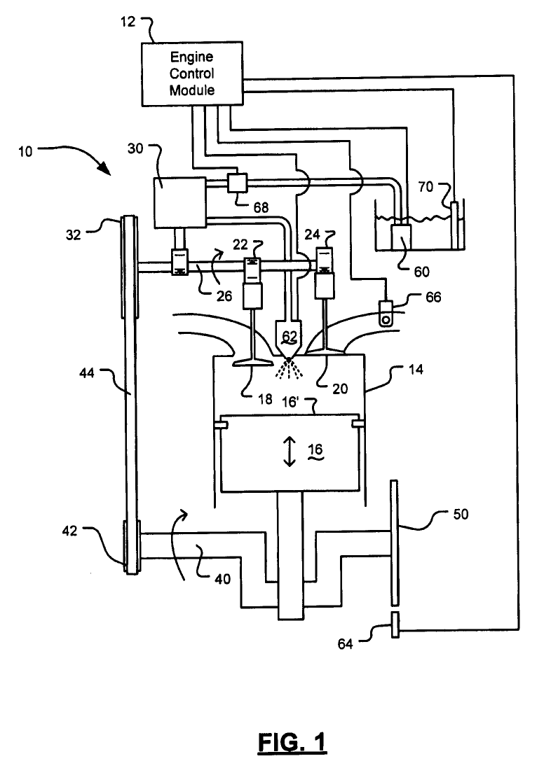

Referring now to FIG. 1, a functional block diagram is shown of a spark-ignition direct-injection (SIDI) engine 10 and an associated engine control module 12. Engine control module 12 employs a method that enables increasing fuel injector pulse widths with increasing percentages of ethanol in the fuel. When compared to the prior art, the method begins injecting fuel earlier, i.e. more crank angle degrees before top dead center of the compression stroke (CAD bTDC), than the prior art. The method is enabled by the inventors' discovery that ethanol produces less exhaust smoke than gasoline when it impinges on a cylinder head 16′. The reduced smoke is believed to be caused by the oxygen content of ethanol (CH₃CH₂OH). Gasoline, which is a mixture of C₅-C₁₀ hydrocarbons, does not include oxygen.

Engine 10 includes a cylinder 14 that contains a reciprocating piston 16. An intake valve 18 opens periodically to allow intake air into cylinder 14. An exhaust valve 20 opens periodically to allow exhaust gas to escape from cylinder 14. Opening and closing of intake valve 18 and exhaust valve 20 are controlled by an associated intake cam lobe 22 and exhaust cam lobe 24. Intake cam lobe 22 and exhaust cam lobe 24 rotate together with a camshaft 26. Camshaft 26 may also include a lobe that drives a mechanical fuel pump 30. It should be appreciated that fuel pump 30 may also be gear driven or electric. A camshaft pulley 32 drives camshaft 26.

Reciprocating piston 16 drives a crankshaft 40. A crankshaft gear 42 rotates with crankshaft 40. Crankshaft gear 42 drives camshaft pulley 32 via a belt or chain 44. In some embodiments the belt or chain 44 may be replaced with gears. A crankshaft position target ring 50 is also attached to crankshaft 40.

Engine control module 12 generates output signals that control an electric fuel pump 60 and a fuel injector 62. A crankshaft position sensor 64 generates a crank position signal based on a position of crankshaft position target ring 50. The crank position signal represents crank angle degrees (CAD) with respect to a predetermined datum. For the purpose of this discussion the crank position is expressed as CAD bTDC. It should be appreciated that CAD bTDC may be converted to CAD with respect to a different datum. Crankshaft position sensor 64 communicates the signal to engine control module 12. Engine control module 12 may also receive one or more signals from at least one of a fuel/air or lambda sensor 66, a fuel tank level sensor 70, and a flexible fuel sensor 68. Lamba sensor 66 indicates the oxygen content of the engine exhaust. The oxygen content can be used to infer the ethanol content of the fuel. Flexible fuel sensor 68 senses and indicates the percentage of ethanol in the fuel. Fuel tank level sensor 70 indicates the quantity of fuel in the vehicle fuel tank. A change in the fuel level indicates that the ethanol content of the fuel in the tank may be changing.

Fuel injector 62 atomizes the fuel directly into the combustion chamber of cylinder 14. Intake valve 18 opens during the intake stroke to allow combustion air into the combustion chamber. To obtain clean combustion with E0 fuel, it is generally desirable to ignite the fuel/air mixture without significant fuel impingement on the piston head 16′. The cleanliness of combustion can be tested with a smoke meter and expressed as a Filter Smoke Number (FSN). In the case of gasoline/ethanol fuel mixtures, the inventors have discovered that impinged fuel does not contribute to smoke generation at the same rate as E0 fuel. This discovery allows the injector pulse width to begin at a greater CAD bTDC, i.e. earlier, than previously believed.

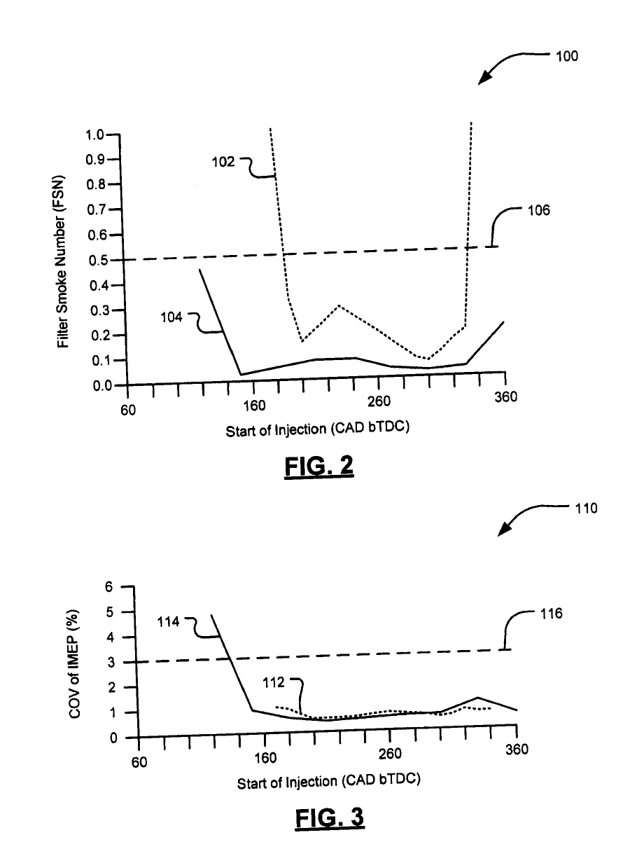

Referring now to FIG. 2, a graph 100 shows, by way of non-limiting example, an example of filter smoke numbers (FSN) for E0 and E85 fuels in SIDI engine 10. The vertical axis of graph 100 represents FSN. The horizontal axis of graph 100 represents start of injection timing expressed as CAD bTDC. A first trace 102 shows the smoke performance of the E0 fuel. A second trace 104 shows the smoke performance of the E85 fuel. Both of the traces were taken at the same engine speed and fuel pressure from fuel pump 30. A predetermined smoke limit 106 is shown at FSN 0.5. It should be appreciated that an FSN value of other than 0.5 may also be used depending on exhaust smoke requirements. Smoke is considered undesirable when it has an FSN that is greater than the smoke limit 106. The smoke emissions were measured with a reflectance method that provides the FSN.

The method of evaluation was to measure the effects of early Start of Injection (SOI) and late End of Injection (EOI) by sweeping the injection timing of fuel injector 62 (best shown in FIG. 1.) The earliest possible SOI is traditionally limited with E0 by smoke emissions that are the result of fuel impingement on piston head 16′. The fuel impingement leads to rich diffusion burning zones. The latest possible EOI is traditionally limited by smoke emissions that are the result of insufficient mixing and/or combustion instability, which also lead to compromised engine output and torque fluctuations.

The engine speed for the traces that are shown in FIG. 2 was chosen such that the exhaust back-pressure was low enough for acceptable smoke meter sampling. Too high of an engine speed may yield prohibitively high exhaust back-pressure for smoke meter sampling.

First trace 102 shows that the earliest acceptable SOI for E0 is smoke limited at approximately 335 CAD bTDC. However, second trace 104 shows that there is no practical smoke limit observed for early SOI with E85. First trace 102 shows that the latest SOI for E0 is smoke limited to 185 CAD bTDC. Second trace 104 shows that the latest SOI for E85 is approximately 115 CAD bTDC. Since the associated injection durations at 2000 RPM and full-load were 40 and 57 CAD for E0 and E85 respectively, the latest acceptable EOI is approximately 145 and 58 deg bTDC of compression for E0 and E85 respectively. Therefore, the maximum injection duration for gasoline at 2000 RPM is approximately 190 CAD.

Referring now to FIG. 3, a graph 110 shows the respective effects of SOI timing on combustion stability. The vertical axis of graph 110 represents combustion stability in terms of coefficient of variation (COV) of indicated mean effective pressure (IMEP). The horizontal axis of graph 110 represents SOI as CAD bTDC. A first trace 112 shows the COV of IMEP performance of the E0 fuel. A second trace 114 shows the COV of IMEP performance of the E85 fuel. Both of the traces were taken at the same engine speed and fuel pressure graph 100 that is shown in FIG. 2. A predetermined COV of IMEP limit 116 is shown as an upper limit for acceptable combustion stability. By way of non-limiting example, COV of IMEP limit 116 is chosen to be 3%.

Second trace 114 shows that the late SOI limit of E85 is constrained at 135 CAD bTDC by combustion variation rather than smoke emissions. When considering the injection duration of E85, the latest acceptable EOI timing is approximately 78 CAD bTDC.

Despite the lack of a smoke constraint for early SOI of E85, there is a practical constraint for early injection of any fuel. Early SOI is limited by short-circuiting of fuel to the exhaust system during the condition that injection occurs while exhaust valve 20 is open (shown in FIG. 1). To avoid this condition, the SOI should be controlled to occur after exhaust valve 20 closes. As a result, the maximum injection duration for E85 at 2000 RPM is approximately 238 crank deg.

Assuming that this behavior as measured at 2000 RPM is representative of the maximum engine speed of 7000 RPM, then the maximum acceptable injection durations are 4.52 and 5.67 milliseconds for E0 and E85 respectively. Since the required injection durations at 7000 RPM engine speed and 15 MPa fuel pressure were measured as 3.92 and 4.79 milliseconds for E0 and E85 respectively, then this worst case engine operating condition can be accomplished for both fuels with the same injector flow rate specification.

It is important to consider the effects of intermediate blends of ethanol and gasoline, which can occur upon refueling of flex-fuel vehicles. Understanding these fuel blends is critical because some of these combustion characteristics may not be linear with respect to ethanol concentration. In particular, any non-linearity in early SOI smoke emissions can require a more sophisticated transition algorithm for intermediate ethanol blends. The response of FSN measurements as function of injection pressure and SOI timing can be analyzed to determine the earliest SOI timing that provides a FSN that is less than the smoke limit 106. Testing has shown that smoke limitations quickly become a factor for early SOI conditions as the amount of gasoline in the fuel blend increases.

Engine-out emissions with E85 at wide open throttle (WOT) operating conditions were comparable and/or lower than that of engine operation with E0.

The early SOI timing described herein allows a lower flow rate fuel injector to satisfy the injector flow rate requirement with E85 fuel at high engine power output, e.g. wide open throttle (WOT). Using lower flow rate fuel injectors enables improved fuel flow control at all operating conditions, including less than WOT.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An engine control system, comprising:
a fuel injector that injects a mixture of ethanol and gasoline directly into a combustion chamber of a spark-ignition direct-injection (SIDI) engine; and
a control module that controls a start of injection of the fuel injector such that the start of injection occurs more than 335 crank angle degrees before a top dead center of a compression stroke of the engine (CAD bTDC).

2. The engine control system of claim 1 wherein the start of injection occurs less than 360 CAD bTDC.

3. The engine control system of claim 1 wherein the start of injection occurs while an exhaust valve of the engine is closed.

4. The engine control system of claim 1 wherein the start of injection is based on a ratio of the ethanol to gasoline.

5. The engine control system of claim 4 further comprising a flexible fuel sensor that communicates a signal to the control module and wherein the signal represents the ratio.

6. A method of controlling a spark-ignition direct-injection (SIDI) engine, comprising:
injecting a mixture of ethanol and gasoline directly into a combustion chamber of a SIDI engine; and
controlling a start of the injecting such that the start occurs more than 335 crank angle degrees before a top dead center of a compression stroke of the engine (CAD bTDC).

7. The method of claim 6 wherein the start occurs less than 360 CAD bTDC.

8. The method of claim 6 wherein the start occurs while an exhaust valve of the engine is closed.

9. The method of claim 6 wherein the start of the injecting with respect to CAD bTDC is based on a ratio of the ethanol to gasoline.

10. The method of claim 9 further comprising determining the ratio.

11. A vehicle powerplant, comprising:
a reciprocating piston internal combustion engine;
fuel injectors that inject a mixture of ethanol and gasoline directly into respective combustion chambers of the engine; and
a control module that controls a start of injection of each fuel injector such that the start of injection occurs at least 335 crank angle degrees before a top dead center of a compression stroke (CAD bTDC) of an associated cylinder and the end of injection occurs by 58 CAD bTDC.

12. The engine control system of claim 11 wherein the start of injection occurs between 360 CAD bTDC and 335 CAD bTDC.

13. The engine control system of claim 11 wherein the start of injection occurs while an exhaust valve of the engine is closed.

14. The engine control system of claim 11 wherein the start of injection is based on a ratio of the ethanol to gasoline.

15. The engine control system of claim 14 further comprising a flexible fuel sensor that communicates a signal to the control module and wherein the signal represents the ratio.
